(19) United States
(12) Patent Application Publication
(10) Pub. No.: US 2025/0169930 A1
(43) Pub. Date: May 29, 2025

(54) Milling Blank and Method for Producing a Shaped Dental Product

(71) Applicant: Kulzer GmbH, Hanau (DE)

(72) Inventors: Frank-Uwe Stange, Langenargen (DE); Matthias Moeller, Eriskirch (DE); Karl-Heinz Renz, Elsenfeld (DE); Stephan Berger, Meckenbeuren (DE)

(21) Appl. No.: 18/832,744

(22) PCT Filed: Dec. 21, 2022
(86) PCT No.: PCT/EP2022/087315

§ 371 Date: Jul. 24, 2024

(30) Foreign Application Priority Data
Jan. 28, 2022 (DE) 10 2022 101 992.6

(51) Int. Cl. A61C 13/00; A61C 13/08

(52) U.S. Cl. CPC A61C 13/0022; A61C 13/0004; A61C 13/081

(57) ABSTRACT

The invention relates to a milling body for producing a dental molding, the milling body comprising a solid body made of a biocompatible first material, a cavity for receiving a fluid polymerizable plastics material being arranged on an upper side of the milling body, the cavity having a bottom and, starting from the edge of the bottom, the cavity being laterally delimited by a circumferential wall, the circumferential wall being annular, and the first material forming the bottom and the solid body extending as far as a lower side of the milling body, which lower side is arranged to be opposite the upper side of the milling body.

The invention also relates to a method for producing dental prostheses using such a milling body, to a set, and to a dental molding produced using such a method.

The invention relates to a milling blank for producing a dental molding, such as a partial or full dental prosthesis or an occlusal splint, and to a method for producing a dental molding using such a milling blank. The milling blank is intended and suitable for subtractive machining and the dental molding manufactured therefrom has to be insertable into a patient's oral cavity for application in the dental sector.

In addition to craft skills, digital manufacturing methods are becoming increasingly significant in the dental sector. Dental prostheses and other dental moldings, for example dental prostheses, crowns, bridges and occlusal splints, have for some years been produced by means of computer-aided design/computer-aided manufacturing (CAD/CAM) technologies using subtractive milling methods. CAD/CAM methods are increasingly also used in the production and design of partial and full dental prostheses with a prosthesis base for lying against the gingiva and prosthetic teeth attached or arranged therein.

For the purposes of digital design of prosthetic work, in particular of partial or full prostheses, the structure is divided into a “white” or tooth-colored tooth portion (the prosthetic teeth) and a gum-colored (“pink”) prosthesis base portion (the prosthesis base). Dental prostheses therefore consist of a gum-colored or pink base and tooth-colored portions (prosthetic teeth or tooth segments).

There are methods, for example the methods known from DE 10 2009 056 752 A1 or WO 2013/124 452 A1, in which a partial or full dental prosthesis is waxed up digitally and produced by means of CAD/CAM methods. Patent DE 103 04 757 B4 discloses a method for producing dental prostheses in which the teeth are virtually waxed-up in a virtual model and a prosthesis base is produced on the basis of the virtual model. EP 2 742 906 A1 discloses a method in which a dental arch is connected to an impression composition, wherein the impression composition is held in an individualized impression tray and contains an impression of the situation in the patient's oral cavity. The surface of the mold with the dental arch is digitized and then a virtual model of the dental arch is computationally positioned and oriented with the best possible fit in the virtual model of the prosthesis base.

For the purposes of digital total prosthetics or partial prosthetics, prosthetic teeth or dental moldings are required which can be clearly and reproducibly adhesively bonded to the prosthesis base.

WO 2016/091 762 A1 discloses a method for producing a dental prosthesis in which a jig is produced with which a plurality of prosthetic teeth can be fastened in the desired location and orientation relative to one another on a prosthesis base. In this case, the prosthetic teeth are shortened by basal grinding in a cervical region, to achieve the desired occlusal height. WO 2016/110 392 A1 discloses a method for producing a dental prosthesis in which a plastically deformable connecting means is introduced into dental alveoli of a prosthesis base in order to enable manual correction of the orientation of the prosthetic teeth in the prosthesis base. DE 10 2008 019 694 B3 discloses a method and an apparatus for producing dental moldings from ceramics with a laser. EP 2 571 451 B1 and EP 2 666 438 A2 disclose methods for producing dental prostheses in which prefabricated prosthetic teeth are embedded in a wax mount and then milled away cervically by means of CAM methods. It is necessary to shorten the prosthetic teeth basally (or cervically) in order to adapt the tooth height to the patient's jaw, i.e. to tailor the occlusal height of the dental prosthesis to the patient's requirements. WO 2014/159 436 A1 discloses a coated dental prosthesis having a reinforcement in the prosthesis base, which is cast into a basal cavity. In addition to dental prostheses, other dental moldings, such as occlusal splints, can also be produced digitally on the basis of patient data using subtractive CAM methods. A drawback of such occlusal splints is that they need to have sufficient abrasion resistance, but this results in a reduced level of wearing comfort on the teeth side. In addition, there are limited options for aesthetically modifying occlusal splints.

Both in additive and subtractive manufacturing, the connection of the base and tooth-colored portions (prosthetic teeth) is a significant challenge. The connection is generally made by adhesive bonding, in which the quality of the transitions owing to the use of too little or too much adhesive and the correct positioning of the prosthetic teeth during adhesive bonding are both prone to error. While one-part, two-colored (gum-colored and tooth-colored) milling blanks, which are also available, do have a very good connection between the layers, the aesthetics are always a compromise and so unsatisfactory due to the predetermined phase boundaries.

US 2013/0101962 A1 discloses a method for producing a dental prosthesis, wherein, in the method, a plurality of indentations are milled in a block along a dental arch, wherein a plurality of plastics materials are introduced into the indentations and, in the meantime, the prosthetic teeth are manufactured from the plastics materials cured in the indentations. The block is then largely machined away and the prosthesis base is manufactured from the block. The method is a multi-stage milling method. Drawbacks of the method according to US 2013/0101962 A1 include the high material loss and the time required to machine away the material of the block, as well as the wear to the tools required for this purpose. EP 2 915 503 B1 discloses a reverse method for producing a dental prosthesis in which a milling blank is subtractively machined from a dental enamel material in order to generate a cavity which is used as a negative shape for a prosthesis base of a dental prosthesis. The occlusal side and the basal side of the dental prosthesis are then subtractively produced from the resulting composite. This is also a multi-stage milling method. A drawback of the method according to EP 2 915 503 B1 is that very large quantities of the relatively hard dental enamel material need to be removed in order to manufacture the dental prostheses. This is not only associated with the loss of a large quantity of the dental enamel material, but the milling tools are also subject to intensive use and a relatively large amount of time is required to implement the method. Furthermore, if the dental enamel material is incompletely removed from the outer sides (the occlusal and oral side) of the prosthesis base, aesthetically troublesome white or tooth-colored residues then remain which have to be removed manually by a dental technician. This can in turn result in an undesired reduction in the material thickness of the prosthesis base.

In the prior art, there are the following options for producing digitally designed full prostheses:
1. Milling or printing the gum-colored base and adhesively bonding it to artificial teeth, alternatively to milled or printed tooth-colored segments. Drawbacks of this can be: manufacturing inaccuracy, time requirement, aesthetic challenges due to adhesive excesses or underfilling of marginal gaps, limitations regarding millability of cavities because of undercuts.
2. Milling premanufactured milling disks having an integrated dual-phase structure. This involves an attempt to achieve natural aesthetics by skillful arrangement of the transitions. The drawback is the position of the gum-colored to tooth-colored transitions, which are always a compromise and aesthetically unsatisfactory.
3. Milling preformed moldings in which prefabricated teeth are already integrated. Mainly, in these methods only the basal side of the prosthesis is still individually manufactured. The drawback is that the compatibility with individual patient cases is extremely limited and many variants of preformed moldings need to be kept available.
4. Layered structure of a prosthesis consisting of tooth-colored individual layers and a prosthesis base by milling and refilling the milled-out cavities multiple times. The drawbacks are the high material loss and the time requirement.

The object of the invention is to overcome the drawbacks of the prior art. In particular, an option needs to be found for providing a method and a milling body for producing a dental molding from two different, securely interconnected materials which make it possible to produce dental moldings in a rapid and resource-saving manner by means of subtractive CAM methods. The materials need to be connected without an adhesive as an adhesion promoter. In particular, the two materials need to be able to be directly joined to one another within the method. To do this, the milling body needs to already have suitable features for implementing the method in the easiest and most straightforward manner possible. The method needs to be as easy and straightforward as possible for the dental technician to implement and the milling body needs to have suitable features for implementing the method. In particular, fully automated or maximally automated methods such as CAD/CAM technologies need to be used and usable.

The objects of the invention are achieved by a milling body according to claim 1, a set according to claim 11, a method according to claim 12 and a dental molding according to claim 24. Preferred variants are claimed in dependent claims 2 to 10 and 13 to 23.

The objects of the invention are achieved by a milling body for producing a dental molding, the milling body comprising a solid body made of a first material, the first material being biocompatible, a cavity for receiving a fluid polymerizable plastics material being arranged on an upper side of the milling body, the cavity having a bottom and, starting from the edge of the bottom, the cavity being laterally delimited by a circumferential wall, the circumferential wall being annular, and the first material forming the bottom and the solid body extending as far as a lower side of the milling body, which lower side is arranged to be opposite the upper side of the milling body.

Theoretically, it can also be provided that a second material, which then formally forms the outer lower side of the milling body, is applied to the lower side of the milling body in regions or over its full surface. In particular, the wall can extend as far as the lower side of the milling body and also project slightly beyond it. However, according to the invention, it is preferable that a surface of the lower side of the milling body is formed by the first material at least in regions or particularly preferably in full and is not covered with another material, because this simplifies the application of the milling body and means that the structure is cost-effective.

It is theoretically possible to produce the circumferential wall by means of a separate annular piece or a separate tube piece, which is placed onto the solid body only just before the application or only during the production method and is securely connected to the solid body in this way or is securely connected to the solid body in another way. Such a configuration should be considered to be according to the invention or at least to be an equivalent.

It can be provided that the first material is a plastics material or a plastics composition, preferably a polymethyl methacrylate (PMMA) or a PMMA-containing plastics composition and/or a hot polymer.

Within the meaning of the present invention, an annular wall comprises a cut-out which surrounds the geometric midpoint of the cut-out. Preferably, the cut-out is formed without undercuts and/or any point in the cut-out is connectable to any other point in the cut-out by a straight line without the straight line extending within the circumferential wall. Preferably, the cut-out is a compact geometric body.

Before machining using a method for producing the dental molding, the cavity preferably does not have any surfaces directly predetermined by the outer surface of the dental molding to be produced, and in particular does not have any tooth contours, dental arches and/or prosthesis base contours. Only the dimensions can be and are preferably coordinated with typical or maximum sizes of dental moldings.

Within the meaning of the present invention, a milling body is understood to be a solid body which is suitable for subtractive machining by milling tools and of which the geometric dimensions are suitable for handling in CAM milling machines.

In milling bodies according to the invention, it can be provided that the circumferential wall has a wall thickness of at most 20 mm, preferably of at most 10 mm, particularly preferably of at most 5 mm. It can also be provided that the circumferential wall is at least 5 mm high, preferably at least 15 mm high.

The height of the circumferential wall relates to the distance of the upper edge of the circumferential wall from the plane of the bottom of the cavity.

The circumferential wall preferably has a uniform wall thickness and/or a uniform height.

As a result, in terms of its dimensions the milling body is highly suitable for use as a semi-finished product for producing dental moldings.

It can also be provided that the milling body has external dimensions of between 50 mm and 150 mm, in particular a diameter of between 50 mm and 150 mm. Such dimensions are useful and sufficient for dental moldings.

Furthermore, it can be provided that a marker for determining a fill level in the cavity is arranged on at least one inner side of the circumferential wall delimiting the cavity, the marker preferably comprising a scale having equidistant calibration marks and/or numbers, particularly preferably a length scale for determining a fill level or a volume of the fluid polymerizable plastics material in the cavity.

This allows the user to introduce the correct desired quantity of fluid polymerizable plastics material into the cavity in a targeted manner. As a result, material is prevented from being wasted and at the same time the time required for the subsequent subtractive machining of the milling body is reduced, and the milling tools are also used more sparingly, where applicable.

As markers, notches can also be arranged in the inner side of the circumferential wall or can be made therein during a method according to the invention. The notches can be used to determine the fill level to which the fluid polymerizable plastics material can be introduced. A bar or a ruler having a suitable length can also be inserted into the notches as an extension beyond the circumference. The ruler can make it easier to reposition the milling body in the CAM device.

Furthermore, it can be provided that the bottom of the cavity is flat and/or the circumferential wall has a cylindrical surface toward the interior of the cavity, the circumferential wall preferably being tubular.

As a result, a milling body that is particularly simple and cost-effective to manufacture is provided.

It can also be provided that the circumferential wall of the milling body is formed by a tube piece or an annular body which is fixed to the solid body, the milling body preferably consisting of the first material and the tube piece or the annular body, or the circumferential wall of the milling body consists of the first material, the solid body and the circumferential wall preferably being formed in one piece, such that the milling body consists of the first material.

Both measures allow for simple and cost-effective production of the milling body.

It can preferably be provided that the tube piece or the annular body is connected to the solid body in a fluid-tight manner. It can likewise be provided that the tube piece or the annular body is adhesively bonded to the solid body circumferentially and/or over its entire surface.

It can preferably also be provided that the first material is a first plastics material, the first plastics material preferably being finally cured.

Plastics materials can be cost-effectively produced. By using a final-cured first plastics material, its shape can be prevented from changing after milling the first plastics material due to post-curing of the first plastics material.

Furthermore, it can be provided that the first material is a layered first plastics material having a plurality of layers of different colors, with layer planes of the layers preferably being arranged in parallel with the bottom of the cavity or being arranged in parallel with a plane that is arranged to be perpendicular to the circumferential wall, in particular in parallel with a base surface of a cylindrical inner wall of the circumferential wall.

Owing to this measure, an aesthetically pleasing dental molding can be manufactured from the first material. This is particularly important when prosthetic teeth are manufactured from the first material. Therefore, according to the invention, the first material is preferably a tooth-colored coated material having layering of different tooth-colored shades, with generally darker layers preferably being arranged toward the cavity. Preferably, the first material is a multilayer material made up of differently colored tooth-colored layers.

Furthermore, it can be provided that the milling body is a blank having a cylindrical outer circumference, the circumferential wall forming a part section of the cylindrical outer circumference, a holder for fixing the blank to a CAM device preferably being arranged on the outer side of the cylindrical outer circumference, the holder particularly preferably being a protruding ring extending circumferentially around the cylindrical outer circumference.

As a result, the milling body can be fixed in any axial orientation in a CAM device. In addition, the milling body can also be repositioned in this way.

It can also be provided that the solid body additionally comprises a shoulder in the cylindrical outer circumference, onto which the circumferential wall is placed and to which the circumferential wall is fastened or fastenable.

According to a preferred configuration, it can be provided that the milling body comprises at least one position marker on a surface outside the cavity, which position marker is visible from the outside and allows the location and orientation of the milling body in the CAM device to be determined, the at least one position marker preferably being arranged in the region of at least one edge of the milling body which is visible from the direction of the upper side and/or the lower side of the milling body, at least two position markers particularly preferably being provided which are visible both from the upper side and from the lower side of the milling body.

As a result, the location and orientation of the milling body in the CAM device can be measured (for example magnetically) and thus checked by means of a camera or by means of another sensor.

It can also be provided that the volume of the material of the circumferential wall is at most half as large as the volume of the cavity, the volume of the material of the circumferential wall is preferably at most a third as large as the volume of the cavity, the volume of the material of the circumferential wall is particularly preferably at most a fifth as large as the volume of the cavity.

This achieves a greater saving on material. In addition, this provides the option of providing a greater volume for a fluid polymerizable plastics material that is to be introduced. As a result, a greater or more voluminous part of the dental molding can be manufactured from the cured plastics material, which is formed by curing the fluid polymerizable plastics material.

Furthermore, it can be provided that the solid body comprises a circumferential shoulder, onto which the circumferential wall is placed, such that the circumferential wall fits flush with the solid body by an inner side, the circumferential wall preferably being bonded to the solid body circumferentially and over its entire surface.

As a result, the manufacturing is simplified and the circumferential wall can be recycled. For this purpose, it can also preferably be provided that the solid body comprises at least one shoulder-shaped circumferential edge for placing an annular body or a tube piece thereon as a circumferential wall.

The objects of the present invention are also achieved by a set for producing a dental molding, comprising an above-described milling body according to the invention and at least one fluid polymerizable plastics material and/or parent components for producing at least one fluid polymerizable plastics material, wherein the set preferably additionally comprises a device for introducing the at least one fluid polymerizable plastics material and/or for producing and mixing the at least one fluid polymerizable plastics material.

The fluid polymerizable plastics material can also be very viscous, but then has to be at least pasty and modelable at room temperature or at the application temperature, but is preferably runny. A runny plastics material has the viscosity in the range of water or rapeseed oil at room temperature.

The set allows the dental molding to be completely manufactured from two different materials and, in this way, completes the device.

The objects of the present invention are further achieved by a method for producing a dental molding using an above-described milling body or using such a set, wherein, in the method, the dental molding is manufactured from at least two different materials, which are joined together in the method, wherein the method is characterized by the following chronological steps:
A) producing a connecting surface between the at least two different materials and a negative shape of a part section of the surface of the dental molding to be produced in the bottom of the cavity in the milling body and in the first material of the milling body by means of a subtractive CAM method in accordance with a virtual three-dimensional model of an outer shape of the dental molding and a shape of the connecting surface of the at least two different materials, the connecting surface and the negative shape adjoining one another and the circumferential wall of the milling body being retained;
B) introducing at least one fluid polymerizable plastics material into the cavity in the milling body and into the volume removed in step A) in the bottom of the milling body, the at least one fluid polymerizable plastics material being introduced into the cavity to a fill level that is such that the circumferential wall comes into contact with at least one last-introduced or externally applied fluid polymerizable plastics material of the at least one fluid polymerizable plastics material, and curing the at least one fluid polymerizable plastics material in the cavity and in the indentations, a cured plastics material being formed in the cavity in the milling body that is connected to the first material of the milling body in a secure and flush manner when curing the at least one fluid polymerizable plastics material;
C) subtractively machining the cured plastics material from the direction of the upper side of the milling body using a CAM method in accordance with a basal surface of the virtual model of the dental molding and subtractively machining the first material from the direction of the lower side of the milling body using a CAM method in accordance with an occlusal surface of the virtual model of the dental molding, such that the dental molding is subtractively worked out of the cured plastics material and the first material connected thereto.

According to the invention, it can be provided that, in step C), basal subtractive machining of the cured plastics material is carried out from the direction of the upper side of the milling body and occlusal subtractive machining of the first material is carried out from the direction of the lower side of the milling body.

According to the invention, the first material preferably has greater abrasion resistance than the cured plastics material that results from polymerization of the fluid polymerizable plastics material.

A dental molding is understood to be a molding which is used in dentistry or dental care and of which the outer shape bears reference to anatomically specific surfaces in a patient's oral cavity. Examples of this are dental prostheses, partial dental prostheses, full dental prostheses, also comprising individual teeth or parts of teeth, occlusal splints, orthodontic buckles and parts of moldings of this kind.

According to the invention, the dental molding to be produced from the milling body is preferably a dental prosthesis. The milling bodies are particularly suitable for producing dental prostheses, and the advantages of the present invention make a particularly strong impact when a dental prosthesis is produced using the milling blank. The same applies to the method according to the invention, which is likewise particularly suitable for producing dental prostheses.

The difference between the at least two different materials can be found in a different shade of the at least two different materials but, alternatively or additionally, can be produced by other different physical properties, such as the abrasion resistance, the hardness, the transparency, the elastic deformability and/or the elasticity.

A subtractive method is understood to be a material-removing method, for example, and preferably according to the invention, a milling method. Such a milling method can particularly preferably be carried out using a computer-controlled multi-axis milling machine as the CAM device.

The cured plastics material is preferably biocompatible at least with the surface of the dental molding.

It can be provided that the milling body is fastened in the CAM device before step C) and preferably after step B), in particular by means of a holder of the milling body.

The curing can take place using a ram for exerting pressure on the fluid polymerizable plastics material.

In the method according to the invention, it can be provided that the negative shape of the part section of the surface of the dental molding that is produced in step A) in the bottom of the cavity in the milling body and in the first material of the milling body is generated to have an offset, the offset enlarging the volume of the virtual model of the dental molding in a region in which the dental molding is not intended to consist of the first material.

An offset for the negative shape of the part section of the surface of the dental molding is understood to mean an extension of the surface of the molding, in particular a uniform extension of the surface of the dental molding, toward a greater volume of the dental molding. It is thus achieved that the subsequent subtractive machining from the direction of the lower side of the milling body (in particular the occlusal direction of the dental molding) can be carried out in the plastics material according to the virtual model without the offset. This can ensure that, after the subtractive machining of the milling body from the direction of the lower side of the milling body, no residues of the first material remain on the surface of the dental molding and, in this way, the aesthetic appearance and/or the physical properties of the dental molding manufactured using the method are not negatively impacted. For example and according to the invention, the offset can preferably be achieved in that the surfaces of the virtual model of the dental molding that are oriented toward the lower side of the milling body and are not intended to consist of the first material are computationally supplemented with a distance vector. In this case, the distance vector can be oriented toward the lower side of the milling body, such that there is a parallel shift of the surfaces of the virtual model of the dental molding that are not intended to consist of the first material. Alternatively, the distance vector can also be arranged to be perpendicular to the surface of the virtual model of the dental molding, such that the surfaces of the virtual model in question are uniformly extended. Further equivalent or similar options for applying a distance vector or other calculation methods for generating the offset are readily conceivable and feasible for a person skilled in the art.

Furthermore, it can be provided that the dental molding is an occlusal splint, the first material having a greater hardness than the cured plastics material, or the dental molding is a dental prosthesis in the form of a partial or full dental prosthesis, the dental prosthesis comprising a prosthesis base and at least one prosthetic tooth and the at least one prosthetic tooth being manufactured from the first material and the prosthesis base being manufactured from the cured plastics material, the first material being tooth-colored and the cured plastics material being gum-colored, the first material preferably having a greater hardness and/or abrasion resistance than the cured plastics material.

This ensures that the occlusal surfaces, which are particularly highly loaded when the dental molding is used, or the prosthetic teeth have a greater hardness and/or abrasion resistance than the basal surfaces of the dental molding that come into contact with the teeth and/or the oral mucosa, or the prosthesis base bearing the prosthetic teeth has other physical properties that are suitable for the purpose in question.

A greater Vickers hardness can in particular be provided as the greater hardness. The abrasion resistance characterizes the resistance to material loss (tooth wear) due to the effect of grinding (tooth abrasion). The abrasion resistance of artificial teeth is a test of the abrasion behavior of artificial teeth in dentistry. The same also applies to other materials used on the occlusal surfaces. Methods for determining this are known to a person skilled in the art in dental technology, for example for WO 2016/008857 A1 and the sources cited therein.

Furthermore, it can be provided that in step B), at least one of the at least one fluid polymerizable plastics materials fully wets at least the surfaces generated in the first material in step A) during introduction.

This ensures that a stable connection is generated between the first material and the cured plastics material.

It can preferably also be provided that in step C), the first material and the cured plastics material are subtractively machined from the direction of the lower side of the milling body using the CAM method in accordance with the occlusal surface of the virtual model of the dental molding.

It can also be provided that in step C), the cured plastics material and the first material are subtractively machined from the direction of the upper side of the milling body using the CAM method in accordance with the basal surface of the virtual model of the dental molding.

In particular during production of a partial or full dental prosthesis it is expedient to also occlusally machine the cured plastics material from the direction of the lower side of the milling body using the CAM method in step C) in addition to occlusally subtractively machining the first material, such that the prosthesis base of the partial or full dental prosthesis consists of the cured plastics material at least on the visible surfaces or all of the occlusal surfaces, and therefore is gum-colored and does not have any tooth-colored points that could impair the aesthetic appearance of the partial or full dental prosthesis.

Theoretically, the tooth-colored first material can also be visible at the contact surface on the edentulous jaw or on the oral mucosa.

Machining the cured plastics material from the lower side of the milling body (the occlusal direction) and the first material from the upper side of the milling body (the basal direction) can also be useful for other dental moldings.

Furthermore, it can be provided that in step A), at least one marker is applied to the inner side of the circumferential wall delimiting the cavity in the milling body, in particular, the at least one marker is generated in the inner side of the circumferential wall by the subtractive CAM method, the distance between the at least one marker and the bottom of the cavity being determined in accordance with the virtual model of the dental molding, the at least one marker preferably being at least one calibration mark, in step B), the at least one fluid polymerizable plastics material being introduced up to the height of the at least one marker in the cavity.

As a result, material of the at least one fluid plastics material can be saved, there is less waste, and the subsequent subtractive machining of the cured plastics material from the upper side of the milling body can be carried out more rapidly, with the tools of the CAM device used for this purpose being used more sparingly.

In this case, it can be provided that the at least one marker is generated in the region of at least one existing marker, such as at least one scale, on the inner side of the circumferential wall. The user can then gauge the quantity of the volume to be introduced using this marker or scale, where necessary. This is achieved in particular when the user knows the volume removed from the first material in step A) or when this is displayed to the user on a display. This volume can be easily calculated on the basis of the virtual model of the dental molding minus the part to be manufactured from the first material, optionally plus the offset, and from the location of the negative shape in the first material.

It can be provided that before step A) or before step B) and after step A), an annular body or a tube piece is fastened to the solid body, such that the annular body or the tube piece forms the circumferential wall, the annular body or the tube piece preferably being removed again after step B) or before step C).

As a result, an annular body or tube piece that is suitable for the rest of the method is used. In addition, a particularly simple structure can thus be selected for the milling body. It can be provided that the annular body or the tube piece is adhesively bonded to the solid body, the adhesive being applied to the connecting surface over its entire surface and/or circumferentially such that the annular body or the tube piece is connected to the solid body in a fluid-tight manner. This prevents the fluid polymerizable plastics material from being able to run out of the cavity in step B).

Furthermore, it can be provided that before step C), a zero shift is calculated to specify the plane of the surface of the cured plastics material generated in step B), and in step C), the zero shift is taken into account to the effect that the subtractive machining begins in the plane of the surface of the cured plastics material.

As a result, the method can be shortened, since the tool for carrying out the subtractive machining is not guided in the empty space, but rather begins in the regions in which the cured plastics material is present, or at least in the immediate vicinity thereof.

Furthermore, it can be provided that in step C), the position and location of the milling body fastened in the CAM device is determined on the basis of at least one marker on the milling body at least once, and the position and location of the milling body is taken into account while controlling the CAM device, the determination of the position and location of the milling body fastened in the CAM device preferably being determined fully automatically.

This ensures that the dental molding is worked out of the milling body and the cured plastics material in the desired manner. This is important and helpful in particular when the milling body is refastened in the CAM device during step C).

Preferably, it can also be provided that after step A) and before step B), a step A2) is carried out:

A2) cleaning and/or pretreating the connecting surface or the connecting surface and the negative shape or all of the freely accessible surface of the first material on the bottom of the cavity including the connecting surface and the negative shape, a chemical treatment of the surface of the first material preferably taking place during the pretreatment, particularly preferably chemical swelling of the surface of the first material with a monomer liquid, the first material being a plastics composition containing a polymethyl methacrylate (PMMA) or consisting of a PMMA.

As a result, a particularly stable connection is generated between the first material and the cured plastics material.

Furthermore, it can be provided that the introduction of at least one fluid polymerizable plastics material in step B) takes place by plugging and/or is carried out at an overpressure, in particular in a pressure pot or in a pressure chamber having a pressure above normal pressure, preferably at a pressure of at least 150 kPa, particularly preferably at a pressure of at least 200 kPa, most particularly preferably at a pressure of at least 200 kPa and at most 400 kPa.

As a result, entrapped air between the first material and the introduced fluid polymerizable plastics material is expelled and thus weak points or surface damage in the dental molding can be prevented or reduced. For this purpose, a “Palamat Elite” pressure polymerization unit can be used, for example. Furthermore, during the plugging or while applying an overpressure when introducing the at least one fluid polymerizable plastics material in step B), boiling bubbles can be avoided, as occur in MMA-based plastics materials, for example.

It can be provided that the introduction of at least one fluid polymerizable plastics material in step B) takes place by plugging and/or is carried out at an overpressure, in particular in a pressure pot or in a pressure chamber, at a pressure of at most 1,000 kPa, preferably at a pressure of at most 500 kPa, particularly preferably at a pressure of at most 400 kPa.

It can also be provided that the introduction of at least one fluid polymerizable plastics material in step B) takes place by plugging and/or is carried out at an overpressure, preferably at a pressure of at least 100 kPa and at most 1,000 kPa, particularly preferably at a pressure of at least 150 kPa and at most 500 kPa, most particularly preferably at a pressure of at least 200 kPa and at most 400 kPa.

It can also be provided that the curing of the fluid polymerizable plastics material in step B) takes place under the effect of heat and/or pressure, the curing preferably taking place over a period of between 10 minutes and 120 minutes, particularly preferably of between 30 minutes and 60 minutes.

As a result, good strength of the cured plastics material can be achieved. A hot polymer or cold polymer is preferably used as the cured plastics material that is produced from the fluid polymerizable plastics material, and the parent components of a hot polymer or cold polymer are used as the fluid polymerizable plastics material. As a result, the cured plastics material and the dental molding are also suitable for allergy sufferers. Therefore, a hot polymer or cold polymer that has, however, preferably already undergone final curing is also suitable for the first material.

The objects underlying the present invention are also achieved by a dental molding, in particular a dental prosthesis or occlusal splint, produced using an above-described method.

The invention is based on the surprising findings that, by providing and using a cavity for introducing a fluid polymerizable plastics material as the second material on an upper side of a milling body for producing a dental molding, it is possible to reduce the quantity of the first material that needs to be subtractively milled out or removed by skillfully selecting the location of the occlusal side of the dental molding during the CAD calculation for the associated CAM method. Specifically, it is then sufficient to place the basal surface of the more abrasion-resistant prosthetic teeth or the occlusal part of the dental molding in the region of the bottom of the cavity. The lighter and more easily millable plastics material for producing the prosthesis base or the basal part can then be easily introduced into the generated cavity and, in so doing, also only needs to be introduced into the cavity up to the desired height, such that this also results in a material saving for the second plastics material. Any material saving automatically results in a time saving and in more sparing use of the tools being used, in particular when particularly abrasion-resistant materials need to be machined.

By means of the present invention, in particular by means of the milling body, the set and the method according to the invention, high accuracy of fit of the dental molding is achieved by directly milling the final shape. There is therefore no effort required for adhesively bonding prosthetic teeth, and no homogeneities arise in the dental molding due to a joining process. At the same time, by completely curing the solid body made of the first material, it is possible to obtain a particularly abrasion-resistant material for prosthetic teeth and, by using a layered first material, a particularly aesthetically pleasing prosthetic tooth material. In dental prostheses, there is a natural color transition from the gum color to the tooth color in the right places, and compromises need not be made in this respect. Particularly good aesthetics can be achieved here by using multilayer milling disks as tooth-colored solid bodies.

Production from the milling body according to the invention and using the method according to the invention can be carried out in just a two-stage production process. A two-stage method can therefore be used for producing the dental molding. Furthermore, different shape variants of blanks or milling bodies are not required. However, a very small set of different sizes of milling blanks can also be used or can be advantageous.

The cavity in the milling body allows for reduced milling effort together with less material removal being required and less tool wear or milling wear. The user can determine and modify the shade of the fluid polymerizable plastics material themselves; for example, they can select or generate a veined look. The inner fill-level marker, which can already be present or can be generated in the first milling process, allows for process-reliable filling before the second milling process.

An exemplary method according to the invention for producing a dental prosthesis (full dental prosthesis or partial dental prosthesis as the dental molding) can have the following sequence:
1. Digitally designing the prosthetic work and separating it into a plurality of data segments. Data regarding the occlusal or oral upper side, the basal lower side of the dental prosthesis and intermediate-area data consisting of the basal area of the tooth-colored portions and the upper side (oral side) of the gum-colored portions as the connecting surface are required. When compiling the data regarding the occlusal or oral upper side, an additional offset to the gum-colored portions possibly needs to be provided in the CAD.
2. Developing a suitable milling strategy for handling the individual process steps. One-sided machining of the lower side, a zero shift tailored to the milling body used and preferably a further zero shift for the machining of both sides with corresponding zero shift for the upper side and lower side separately from one another are required.
3. Fastening a milling body corresponding in size at least to the tooth-colored portions or a tooth-colored solid body of the milling body in the milling machine and milling the intermediate-area data and the data regarding the occlusal or oral upper side of the prosthesis base from the basal side, potentially with a slight offset of the gum-colored portions (the prosthesis base) in the oral direction. The milling body or the tooth-colored solid body can preferably be provided before positioning using a position marker, which allows for repositioning.
4. Removing the partially milled blank and optionally fitting a cylindrical annular body as a circumferential wall of the milling body for producing the cavity on the upper side for more easily filling up the milled-out regions and required additional volumes, provided that the milling body does not already comprise a cavity delimited by the circumferential wall on the upper side, the circumferential wall preferably being formed in one piece with the solid body of the milling body here.
5. Filling up or partially filling the cavity with a prosthesis material in the form of a fluid polymerizable plastics material (preferably with a powder-liquid system) and polymerizing it in the analogous manufacturing method. Then, optionally removing the support ring and, where necessary, post-treating the cured plastics material, for example by storage in water.
6. Repositioning the filled partially milled blank in the milling machine and milling the outer geometries basally and orally in accordance with the final prosthesis design.

If a milling body having a tooth-colored solid body and a hollow shape made on one side for reducing the milling effort is then used, a cylindrical annular body does not need to be attached, as set out in point 4.

A fill marker or other suitable indicator can be applied within the hollow shape during step 3. in order to allow the user to verifiably ensure, in step 5., sufficient but not excessive subsequent filling with the fluid polymerizable plastics material.

To complete the method, a surface finish can be provided by polishing and/or chemical treatment of the dental prosthesis.

Exemplary embodiments of the invention are explained below on the basis of eleven schematic figures without, however, limiting the invention. In the drawings:

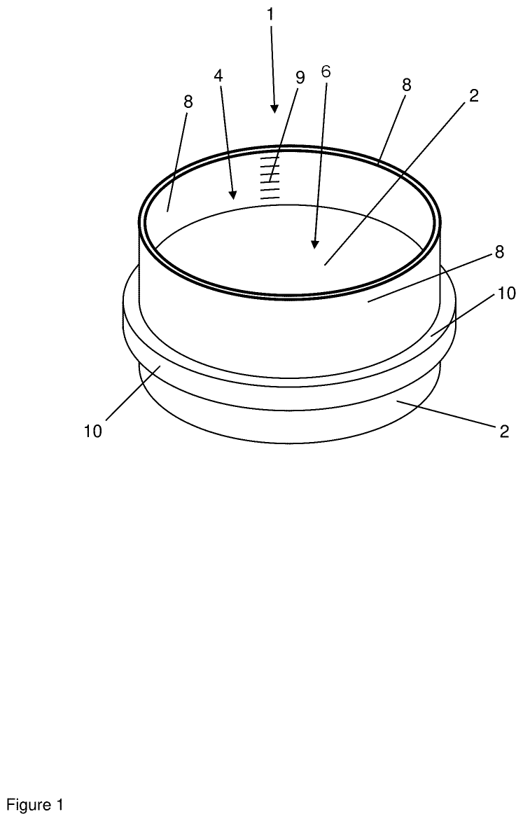

FIG. 1 is a schematic perspective view of an upper side of a first milling body according to the invention;

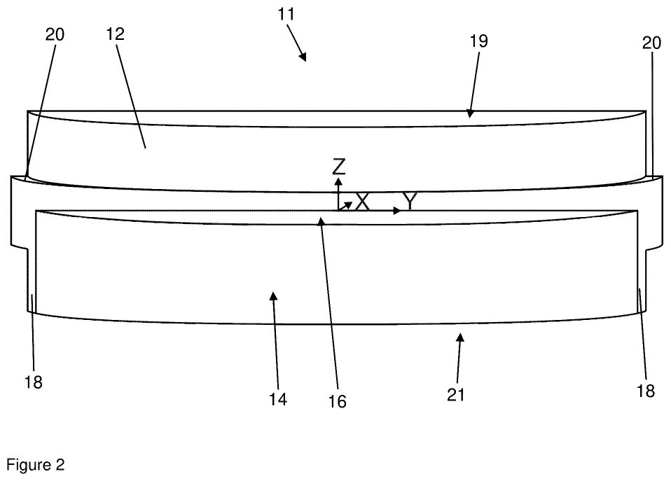

FIG. 2 is a schematic perspective transparent view of a lateral side of a second milling body according to the invention;

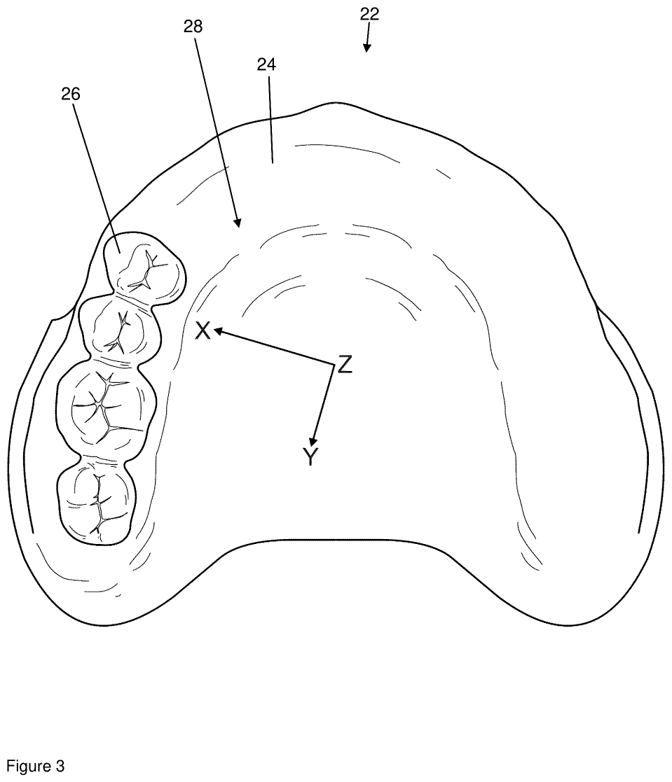

FIG. 3 is a schematic perspective view of an occlusal side of a dental prosthesis produced using a method according to the invention by means of a milling body according to the invention;

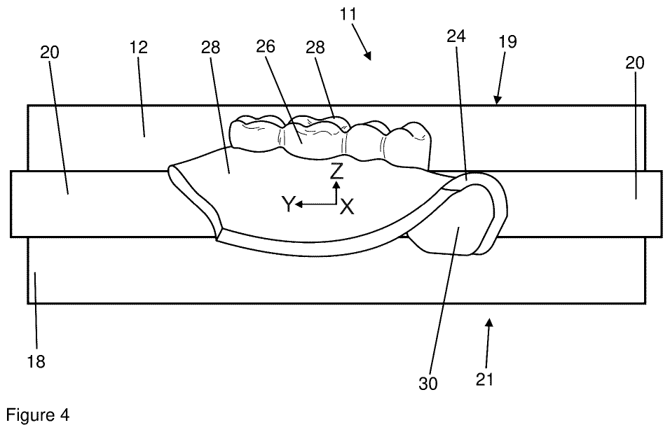

FIG. 4 is a schematic side view of the milling body according to FIG. 2 with a cross-sectional view and a location of the dental prosthesis to be produced thereby according to FIG. 3;

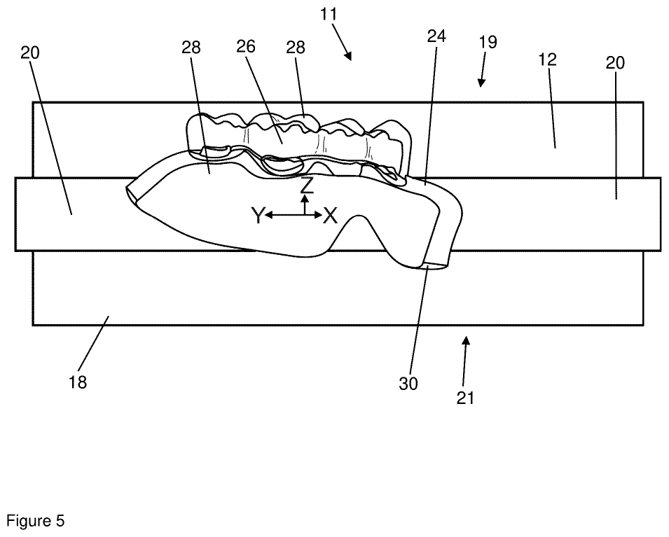

FIG. 5 is a schematic side view of the milling body according to FIGS. 2 and 4 with a cross-sectional view in another sectional plane and the location of the dental prosthesis to be produced thereby according to FIG. 3;

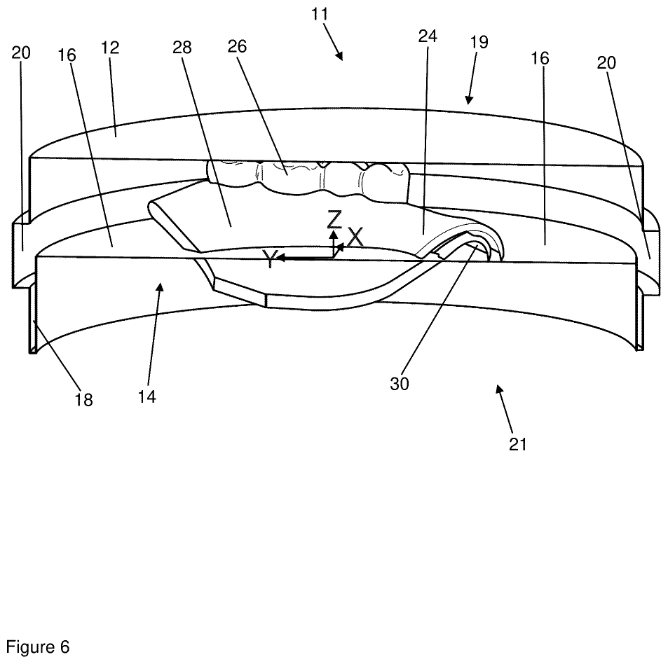

FIG. 6 is a schematic perspective view of the location of the dental prosthesis according to FIG. 3 in the milling body according to FIGS. 2, 4 and 5;

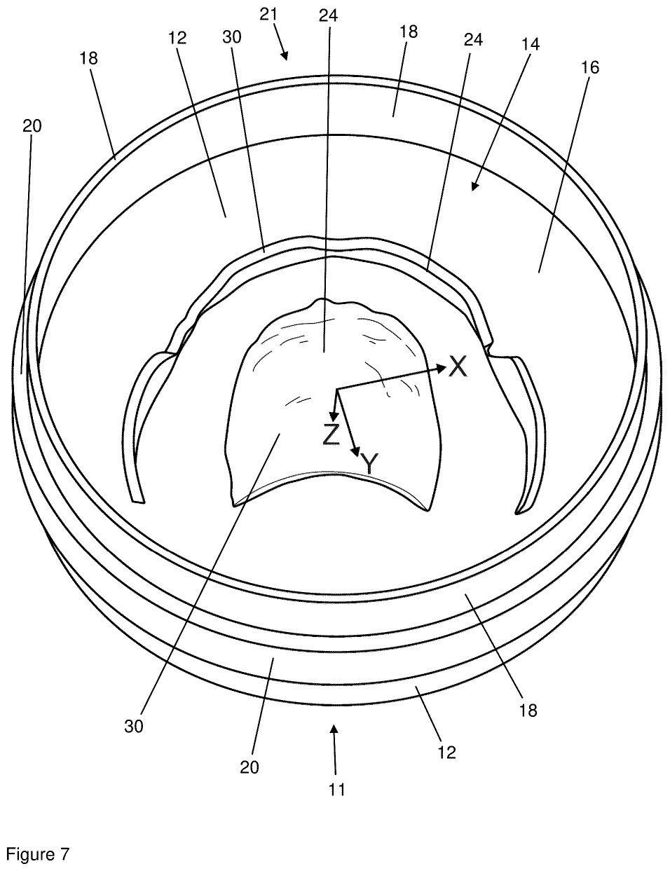

FIG. 7 is a schematic perspective view of the upper side of the milling body according to FIGS. 2 and 4 to 6 with the basal portions of the prosthesis base of the dental prosthesis protruding from the bottom of the cavity according to FIG. 3;

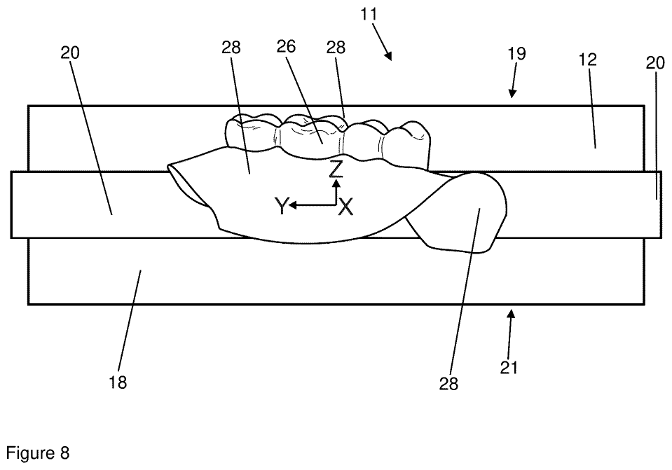

FIG. 8 is a schematic side view of the milling body according to FIGS. 2 and 4 to 7 with a cross-sectional view and the location of the occlusal surfaces of the dental prosthesis to be produced thereby according to FIG. 3;

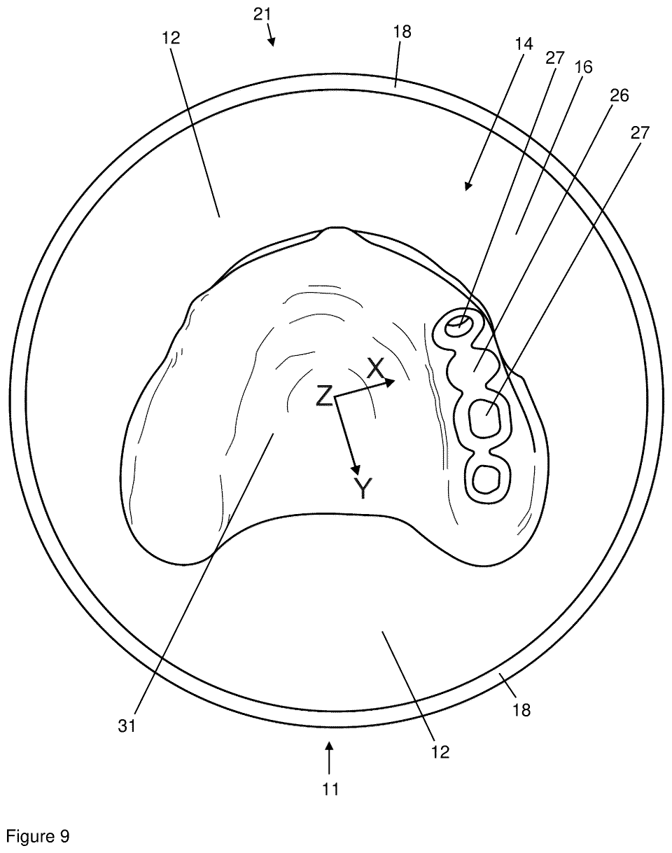

FIG. 9 is a schematic view of the upper side of the milling body according to FIGS. 2 and 4 to 8 after subtractively working out the connecting surface and the negative shape for the oral side of the prosthesis base;

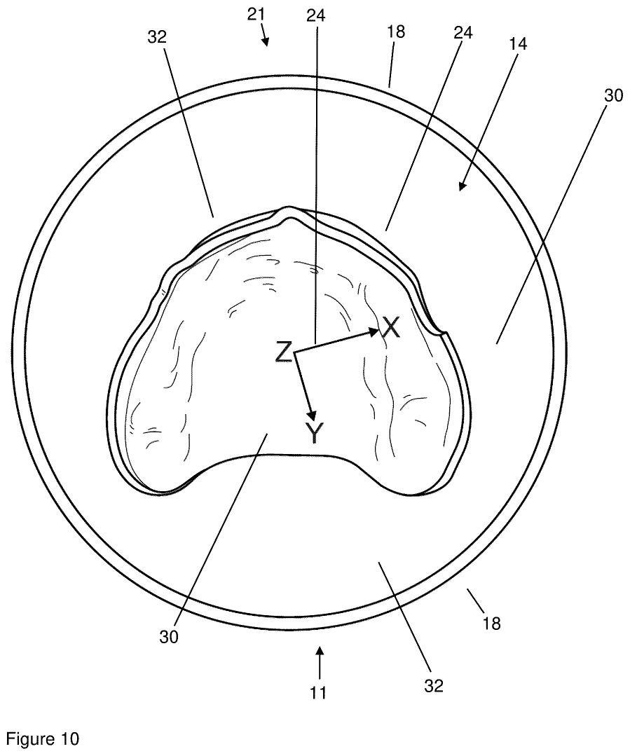

FIG. 10 is a schematic view of the basal side of the dental prosthesis after subtractive working out from the previously introduced and then cured plastics material; and

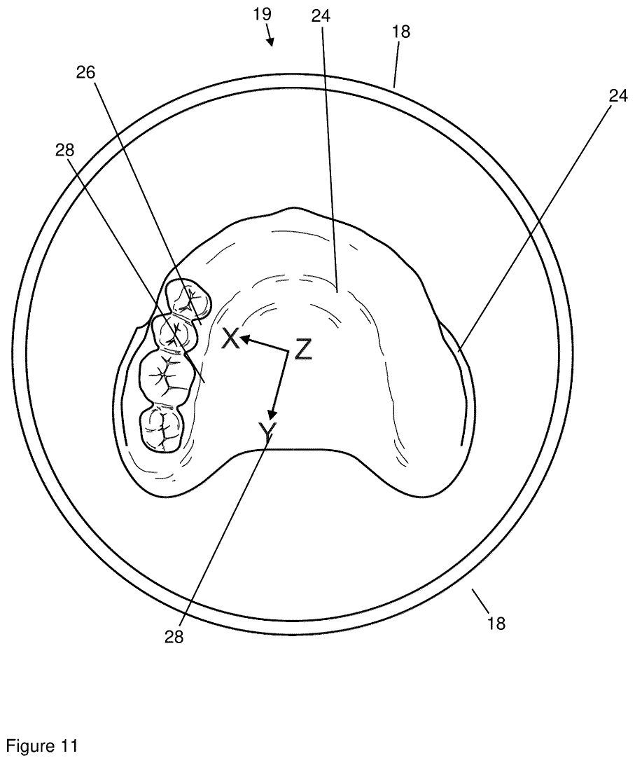

FIG. 11 is a schematic view of the occlusal or oral side of the dental prosthesis after subtractive working out from the first material and the previously introduced polymerized cured plastics material.

FIG. 1 is a schematic perspective view of an upper side (at the top in FIG. 1) of a first milling body 1 according to the invention. The milling body 1 comprises a solid body 2 made of a first material. The solid body 2 extends as far as a lower side opposite the upper side of the milling body 1 (not visible in FIG. 1). The first material can be a fully polymerized tooth-colored plastics material, which is suitable for producing prosthetic teeth and has the required abrasion resistance for this purpose. The first material preferably already needs to be biocompatible, as is the case for the milling body 1, in order to be suitable for applications in a patient's oral cavity.

A cavity 4 having a bottom 6 is arranged on the upper side of the milling body 1, the cavity 4 being laterally delimited by a circumferential wall 8. The bottom 6 is (preferably completely) formed by the solid body 2. The circumferential wall 8 can consist of the first material or of another material. In particular, the circumferential wall 8 can be an annular body or a tube piece, which is placed onto the solid body 2 and securely connected thereto. The connection can be made by adhesive bonding. The solid body 2 can be cylindrical in shape. The solid body 2 can comprise a shoulder on the outer circumference for placing on an annular body or tube piece as the circumferential wall 8, onto which shoulder the annular body or the tube piece is placed so as to be flush. The circumferential wall 8 can in particular be a cylindrical tube piece. The circumferential wall 8 can also be a metal annular body.

A marker 9 for determining a fill level in the cavity 4 can be arranged on an inner side of the circumferential wall 8 facing the cavity 4. The marker 9 can, however, also be applied to, for example milled into, the circumferential wall 8 only during a method for producing a dental molding. On the basis of the marker 9, the fluid polymerizable plastics material (not shown in FIG. 1) to be introduced into the cavity 4 can be introduced up to the correct height.

At least one holder 10 for fixing the milling body 1 in a CAM device can be arranged on at least one outer wall of the milling body 1. The holder 10 can project from the outer wall of the milling body 1 in the form of a placed-on torus having a rectangular cross-sectional area. As an alternative to the holder 10 shown in FIG. 1, the holder can also be produced in another way, for example by means of protruding projections or by means of indentations in the side surfaces. The holder 10 is used for fastening in a CAM device (not shown).

The milling body 1 according to FIG. 1 can be used as follows in a method according to the invention. The milling body 1 is fixed in a subtractive CAM device, such as a computer-controlled multi-axis milling machine, by means of the holder 10. By means of a virtual CAD model of a dental molding to be generated, a surface is generated in the bottom 6, which corresponds to the connecting surface between the first material and the cured plastics material to be produced from the fluid polymerizable plastics material in accordance with the virtual CAD model. In addition, the occlusal or oral surfaces of the surfaces consisting of the cured plastics material are worked out of the solid body 2 as a negative shape using the subtractive CAM device. An offset can be used here such that the negative shape is worked somewhat deeper, preferably at least a few tens of a millimeter deeper, into the solid body 2 than the occlusal or oral surface would require for the cured plastics material according to the CAD model for a direct negative shape. In addition, the marker 9 can be generated on the circumferential wall 8 only in this step. The thus newly generated surface in the bottom 6 of the solid body 2 can then be cleaned.

The fluid polymerizable plastics material (not shown) can then be introduced into the cavity 4 and specifically up to a height that is sufficient for the part of the dental molding consisting of the cured plastics material to be completely worked out of the cured plastics material on the basal side according to the virtual CAD model. The fluid polymerizable plastics material can cure under the effect of pressure and temperature and forms the cured plastics material. The intermediate product can then be fastened in the subtractive CAM device again and the dental molding is worked out by means of the CAM device on the basis of the occlusal or oral surfaces and the basal surfaces of the virtual CAD model of the dental molding. A first part of the dental molding (for example prosthetic teeth) then consists of the first material of the molding and a second part of the dental molding (for example a prosthesis base) then consists of the cured plastics material.

As an alternative to a dental prosthesis, using the method an occlusal splint can be produced in the same way, the occlusal surfaces of which consist of the first material and the basal surfaces of which abutting a patient's teeth consist of the cured plastics material. This can be used to combine suitable material properties and/or to generate aesthetically pleasing color gradients.

FIG. 2 is a schematic perspective transparent side view of a second milling body 11 according to the invention. The milling body 11 comprises a solid body 12 made of a first material. The solid body 12 extends as far as a lower side 19, which is arranged to be opposite an upper side 21 of the milling body 11. The first material can be a fully polymerized tooth- colored plastics material, which is suitable for producing prosthetic teeth and has the required abrasion resistance for this purpose. The first material already needs to be biocompatible, as is the case for the milling body 1, in order to be suitable for applications in a patient's oral cavity.

A cavity 14 having a bottom 16 is arranged on the upper side 21 of the milling body 11, the cavity 14 being laterally delimited by a circumferential wall 18. The bottom 16 is preferably completely formed by the solid body 12. The circumferential wall 18 can consist of the first material or of another material. In particular, the circumferential wall 18 can be an annular body or a tube piece, which is placed onto the solid body 12 and securely connected to the solid body 12. The connection can be made by adhesive bonding. The solid body 12 can be cylindrical in shape. The circumferential wall 18 can be a cylindrical tube piece. The circumferential wall 18 can also be a metal annular body.

A marker (not visible in FIG. 2) for determining a fill level in the cavity 14 can be arranged on an inner side of the circumferential wall 18 facing the cavity 14. The marker can, however, also be applied to, for example milled into, the circumferential wall 18 only during a method according to the invention. On the basis of the marker, the fluid polymerizable plastics material (not shown in FIG. 2) to be introduced into the cavity 14 can be introduced up to the correct height.

At least one holder 20 for fixing the milling body 11 in a CAM device can be arranged on at least one outer wall of the milling body 11. The holder 20 can project from the outer wall of the milling body 1. The holder 20 can be formed by a protruding circumferential ring.

FIG. 3 is a schematic perspective view of a dental prosthesis 22 produced using a method according to the invention by means of a milling body 1, 11 according to the invention. The dental prosthesis 22 comprises a prosthesis base 24 made of a gum-colored cured plastics material. A plurality of prosthetic teeth 26 can be connected to the prosthesis base 24 as a one-piece row of teeth. The prosthetic teeth 26 consist of the first material and are tooth-colored, preferably structured with colored layers, in order to ensure a particularly good aesthetic appearance. The prosthetic teeth 26 and the prosthesis base 24 are directly interconnected when they have been produced using a method according to the invention. FIG. 3 shows the occlusal or oral surfaces 28 of the dental prosthesis 22. The dental prosthesis 22 is generated by means of a virtual CAD model, which has been constructed in advance in a known manner on the basis of patient data and further processing where necessary, the virtual CAD model for implementing a method according to the invention being computationally separated into a tooth-colored part for the prosthetic teeth 26 and a gum-colored part for the prosthesis base 24. In addition to the data regarding the occlusal or oral surfaces 28 of the dental prosthesis 22, the virtual CAD model comprises the data regarding the basal side of the dental prosthesis 22 (not visible in FIG. 3) opposite the occlusal or oral surface 28 as well as the data regarding the connecting surface between the prosthetic teeth 26 and the prosthesis base 24. The connecting surface is preferably within the dental prosthesis 22 here. The image shown in FIG. 3 therefore also corresponds to the outer shape of the virtual CAD model.

On the basis of FIGS. 4 to 10, the sequence of a method according to the invention will be explained below by way of example using the milling body 11 according to FIG. 2 and the virtual CAD model of the dental prosthesis 22 according to FIG. 3.

On this, FIG. 4 is a schematic side view of the milling body 11 according to FIG. 2 with a cross-sectional view and a location of the dental prosthesis 22 to be produced thereby according to FIG. 3. The virtual CAD model of the dental prosthesis 22 is therefore mapped over the milling body 11 or into the milling body 11 in the desired location in the milling body 11. As is also the case in some of the following figures, this makes it possible to imagine how the dental prosthesis 22 to be produced is situated in the milling body 11 before it has been worked out. Here, the prosthetic teeth 26 are positioned in the milling body 11 such that they are completely contained in the region of the solid body 12 made of the first material. This is shown somewhat more clearly in a cross-sectional view shown in FIG. 5 than in FIG. 4, since the virtual CAD model of the dental prosthesis 22 is shown in a cross section through the prosthetic teeth 26. A basal surface 30 of the virtual CAD model of the dental prosthesis 22 is, however, partly arranged in the cavity 14, which is subsequently filled with the fluid polymerizable plastics material. This is shown somewhat more clearly in the perspective view in FIG. 6, and especially in the schematic perspective view of the upper side of the milling body 11 according to FIG. 7, which shows the basal portions of the prosthesis base 24 of the dental prosthesis 22 protruding from the bottom 16 of the cavity 14.

First, the occlusal or oral surface 28 of the prosthesis base 24 and the connecting surface between the prosthetic teeth 26 and the prosthesis base 24 are generated in the solid body 12 of the milling body 11 using a subtractive CAM device, such as a computer-controlled multi-axis milling machine, on the basis of the virtual CAD model. For this purpose, by means of the virtual CAD model, a surface is generated in the bottom 16, which corresponds to the connecting surface between the first material and the cured plastics material to be produced from the fluid polymerizable plastics material in accordance with the virtual CAD model. In addition, the occlusal or oral surfaces 28 of the surfaces consisting of the cured plastics material are worked out of the solid body 12 as a negative shape 31 using the subtractive CAM device. An offset can be used here such that the negative shape 31 is worked at least a few tens of a millimeter deeper into the solid body 12 than the occlusal or oral surface 28 would require for the cured plastics material. The negative shape 31 thus acts as casting mold for producing the occlusal or oral side of the prosthesis base 24. The thus generated surface in the first material is clearly shown in the schematic view of the upper side of the thus machined milling body 11 according to FIG. 9. The connecting surface between the prosthetic teeth 26 and the prosthesis base 24 corresponds, in FIG. 9, to the surface formed by the region of the solid body 12 that is part of the prosthetic teeth 26 and is already designated as prosthetic teeth 26 in FIG. 9. In this connecting surface of the prosthetic teeth 26, there are indentations 27, into which the fluid polymerizable plastics material is introduced for a more stable connection.

In addition, a marker can be generated on the circumferential wall 18. The thus newly generated surface can then be cleaned. The cavity 14 shown in FIG. 9 can then be filled or plugged with the fluid polymerizable plastics material up to the marker. The fluid polymerizable plastics material can then be cured (preferably under pressure and/or at an increased temperature compared with room temperature) (preferably for 30 to 60 minutes) in order to form the cured plastics material 32 (see FIG. 10) from which the prosthesis base 24 is produced.

After curing, the thus obtained intermediate product is mounted in the subtractive CAM device (the multi-axis milling machine) again and the occlusal or oral surface 28 of the dental prosthesis 22 (this time without the offset) and the basal surface 30 of the dental prosthesis 22 are subtractively manufactured from the intermediate product according to the virtual CAD model of the dental prosthesis 22. On this, FIG. 10 is a schematic view of the basal side 30 of the dental prosthesis 22 after subtractive working out from the polymerized cured plastics material 32 before the machining of the occlusal or oral side 28 is complete and the dental prosthesis 22 has been detached from the rest of the milling body 11. FIG. 11 lastly shows the dental prosthesis 22 detached from the circumferential wall 18. For final completion, cleaning, polishing and/or surface treatment of the dental prosthesis 22 can be carried out as finishing processes.

The features of the invention disclosed in the above description, as well as in the claims, drawings and exemplary embodiments, can be essential both individually and in any desired combination to realizing the invention in its various embodiments.

### List of Reference Signs

1, 11 Milling body
2, 12 Solid body
4, 14 Cavity
6, 16 Bottom
8, 18 Wall
9 Marker
10 10, 20 Holder
19 Lower side
21 Upper side
22 Dental prosthesis
24 Prosthesis base
26 Prosthetic teeth
27 Cut-out
28 Occlusal surface/oral surface
30 Basal surface
31 Negative shape
32 Plastics material

1. A milling body for producing a dental molding, the milling body comprising a solid body made of a first material, the first material being biocompatible, wherein
a cavity for receiving a fluid polymerizable plastics material is arranged on an upper side of the milling body, the cavity having a bottom and, starting from the edge of the bottom, the cavity being laterally delimited by a circumferential wall, the circumferential wall being annular, and the first material forming the bottom and the solid body extending as far as a lower side of the milling body, which lower side is arranged to be opposite the upper side of the milling body.

2. The milling body according to claim 1, wherein
the circumferential wall has a wall thickness of at most 20 mm, preferably of at most 10 mm, particularly preferably of at most 5 mm, and/or
the circumferential wall is at least 5 mm high, preferably at least 15 mm high.

3. The milling body according to claim 1, wherein
a marker for determining a fill level in the cavity is arranged on at least one inner side of the circumferential wall delimiting the cavity, the marker preferably comprising a scale having equidistant calibration marks and/or numbers, particularly preferably a length scale for determining a fill level or a volume of the fluid polymerizable plastics material in the cavity.

4. The milling body according to claim 1, wherein
the bottom of the cavity is flat and/or the circumferential wall has a cylindrical surface toward the interior of the cavity, the circumferential wall preferably being tubular.

5. The milling body according to any one of the preceding claims, characterized in that claim 1, wherein
the circumferential wall of the milling body is formed by a tube piece or an annular body which is fixed to the solid body, the milling body preferably consisting of the first material and the tube piece or the annular body, or
the circumferential wall of the milling body consists of the first material, the solid body and the circumferential wall preferably being formed in one piece, such that the milling body consists of the first material.

6. The milling body according to claim 1, wherein
the first material is a first plastics material, the first plastics material preferably being finally cured, and/or
the first material is a layered first plastics material having a plurality of layers of different colors, with layer planes of the layers preferably being arranged in parallel with the bottom of the cavity or being arranged in parallel with a plane that is arranged to be perpendicular to the circumferential wall, in particular in parallel with a base surface of a cylindrical inner wall of the circumferential wall.

7. The milling body according to claim 1, wherein
the milling body is a blank having a cylindrical outer circumference, the circumferential wall forming a part section of the cylindrical outer circumference, a holder for fixing the blank to a CAM device preferably being arranged on the outer side of the cylindrical outer circumference, the holder particularly preferably being a protruding ring extending circumferentially around the cylindrical outer circumference.

8. The milling body according to claim 1, wherein
the milling body comprises at least one position marker on a surface outside the cavity, which position marker is visible from the outside and allows the location and orientation of the milling body in the CAM device to be determined, the at least one position marker preferably being arranged in the region of at least one edge of the milling body which is visible from the direction of the upper side and/or the lower side of the milling body, at least two position markers particularly preferably being provided which are visible both from the upper side and from the lower side of the milling body.

9. The milling body according to claim 1, wherein
the volume of the material of the circumferential wall is at most half as large as the volume of the cavity, the volume of the material of the circumferential wall is preferably at most a third as large as the volume of the cavity, the volume of the material of the circumferential wall is particularly preferably at most a fifth as large as the volume of the cavity.

10. The milling body (1, 11) according to claim 1, wherein
the solid body comprises a circumferential shoulder, onto which the circumferential wall is placed, such that the circumferential wall fits flush with the solid body by an inner side, the circumferential wall preferably being bonded to the solid body circumferentially and over its entire surface.

11. A set for producing a dental molding, comprising a milling body according to claim 1, and at least one fluid polymerizable plastics material and/or parent components for producing at least one fluid polymerizable plastics material, wherein the set preferably additionally comprises a device for introducing the at least one fluid polymerizable plastics material and/or for producing and mixing the at least one fluid polymerizable plastics material.

12. A method for producing a dental molding using a milling body according to claim 1, wherein, in the method, the dental molding is manufactured from at least two different materials, which are joined together in the method,
wherein the method comprises the following chronological steps:
A) producing a connecting surface between the at least two different materials and a negative shape of a part section of the surface of the dental molding to be produced in the bottom of the cavity in the milling body and in the first material of the milling body by means of a subtractive CAM method in accordance with a virtual three-dimensional model of an outer shape of the dental molding and a shape of the connecting surface of the at least two different materials, the connecting surface and the negative shape adjoining one another and the circumferential wall of the milling body being retained;
B) introducing at least one fluid polymerizable plastics material into the cavity in the milling body and into the volume removed in step A) in the bottom of the milling body, the at least one fluid polymerizable plastics material being introduced into the cavity to a fill level that is such that the circumferential wall comes into contact with at least one last-introduced or externally applied fluid polymerizable plastics material of the at least one fluid polymerizable plastics material, and curing the at least one fluid polymerizable plastics material in the cavity and in the indentations, a cured plastics material being formed in the cavity in the milling body that is connected to the first material of the milling body in a secure and flush manner when curing the at least one fluid polymerizable plastics material;
C) subtractively machining the cured plastics material from the direction of the upper side of the milling body using a CAM method in accordance with a basal surface of the virtual model of the dental molding and subtractively machining the first material from the direction of the lower side of the milling body using a CAM method in accordance with an occlusal surface of the virtual model of the dental molding, such that the dental molding is subtractively worked out of the cured plastics material and the first material connected thereto.

13. The method according to claim 12, wherein
the negative shape of the part section of the surface of the dental molding that is produced in step A) in the bottom of the cavity in the milling body and in the first material of the milling body is generated to have an offset, the offset enlarging the volume of the virtual model of the dental molding in a region in which the dental molding is not intended to consist of the first material.

14. The method according to claim 12, wherein
the dental molding is an occlusal splint, the first material having a greater hardness than the cured plastics material, or
the dental molding is a dental prosthesis in the form of a partial or full dental prosthesis, the dental prosthesis comprising a prosthesis base and at least one prosthetic tooth and the at least one prosthetic tooth being manufactured from the first material and the prosthesis base being manufactured from the cured plastics material, the first material being tooth-colored and the cured plastics material being gum-colored, the first material preferably having a greater hardness and/or abrasion resistance than the cured plastics material.

15. The method according to claim 12, wherein
in step B), at least one of the at least one fluid polymerizable plastics materials fully wets at least the surfaces generated in the first material in step A) during introduction.

16. The method according to claim 12, wherein
in step C), the first material and the cured plastics material are subtractively machined from the direction of the lower side of the milling body using the CAM method in accordance with the occlusal surface of the virtual model of the dental molding, and/or
in step C), the cured plastics material and the first material are subtractively machined from the direction of the upper side of the milling body using the CAM method in accordance with the basal surface of the virtual model of the dental molding.

17. The method according to claim 12, wherein
in step A), at least one marker is applied to the inner side of the circumferential wall delimiting the cavity in the milling body, in particular, the at least one marker is generated in the inner side of the circumferential wall by the subtractive CAM method, the distance between the at least one marker and the bottom of the cavity being determined in accordance with the virtual model of the dental molding, the at least one marker preferably being at least one calibration mark,
in step B), the at least one fluid polymerizable plastics material being introduced up to the height of the at least one marker in the cavity.

18. The method according to claim 12, wherein
before step A) or before step B) and after step A), an annular body or a tube piece is fastened to the solid body, such that the annular body or the tube piece forms the circumferential wall, the annular body or the tube piece preferably being removed again after step B) or before step C).

19. The method according to claim 12, wherein
before step C), a zero shift is calculated to specify the plane of the surface of the cured plastics material generated in step B), and in step C), the zero shift is taken into account to the effect that the subtractive machining begins in the plane of the surface of the cured plastics material.

20. The method according to claim 12, wherein
in step C), the position and location of the milling body fastened in the CAM device is determined on the basis of at least one marker on the milling body at least once, and the position and location of the milling body is taken into account while controlling the CAM device, the determination of the position and location of the milling body fastened in the CAM device preferably being determined fully automatically.

21. The method according to claim 12, wherein
after step A) and before step B), a step A2) is carried out:
A2) cleaning and/or pretreating the connecting surface or the connecting surface and the negative shape or all of the freely accessible surface of the first material on the bottom of the cavity including the connecting surface and the negative shape, a chemical treatment of the surface of the first material preferably taking place during the pretreatment, particularly preferably chemical swelling of the surface of the first material with a monomer liquid, the first material being a plastics composition containing a polymethyl methacrylate (PMMA) or consisting of a PMMA.

22. The method according to claim 12, wherein
the introduction of at least one fluid polymerizable plastics material in step B) takes place by plugging and/or is carried out at an overpressure, in particular in a pressure pot or in a pressure chamber having a pressure above normal pressure, preferably at a pressure of at least 150 kPa, particularly preferably at a pressure of at least 200 kPa, most particularly preferably at a pressure of at least 200 kPa and at most 400 kPa.

23. The method according to claim 12, wherein
the introduction of at least one fluid polymerizable plastics material in step B) takes place by plugging and/or is carried out at an overpressure, in particular in a pressure pot or in a pressure chamber, at a pressure of at most 1,000 kPa, preferably at a pressure of at most 500 kPa, particularly preferably at a pressure of at most 400 kPa.

24. The method according to claim 12, wherein
the curing of the fluid polymerizable plastics material in step B) takes place under the effect of heat and/or pressure, the curing preferably taking place over a period of between 10 minutes and 120 minutes, particularly preferably of between 30 minutes and 60 minutes.

25. A dental molding, in particular a dental prosthesis or occlusal splint, produced using a method according to claim 12.

26. A method for producing a dental molding using a milling body using a set according to claim 11, wherein, in the method, the dental molding is manufactured from at least two different materials, which are joined together in the method,
wherein the method comprises the following chronological steps:
A) producing a connecting surface between the at least two different materials and a negative shape of a part section of the surface of the dental molding to be produced in the bottom of the cavity in the milling body and in the first material of the milling body by means of a subtractive CAM method in accordance with a virtual three-dimensional model of an outer shape of the dental molding and a shape of the connecting surface of the at least two different materials, the connecting surface and the negative shape adjoining one another and the circumferential wall of the milling body being retained;
B) introducing at least one fluid polymerizable plastics material into the cavity in the milling body and into the volume removed in step A) in the bottom of the milling body, the at least one fluid polymerizable plastics material being introduced into the cavity to a fill level that is such that the circumferential wall comes into contact with at least one last-introduced or externally applied fluid polymerizable plastics material of the at least one fluid polymerizable plastics material, and curing the at least one fluid polymerizable plastics material in the cavity and in the indentations, a cured plastics material being formed in the cavity in the milling body that is connected to the first material of the milling body in a secure and flush manner when curing the at least one fluid polymerizable plastics material;
C) subtractively machining the cured plastics material from the direction of the upper side of the milling body using a CAM method in accordance with a basal surface of the virtual model of the dental molding and subtractively machining the first material from the direction of the lower side of the milling body using a CAM method in accordance with an occlusal surface of the virtual model of the dental molding, such that the dental molding is subtractively worked out of the cured plastics material and the first material connected thereto.
